(19) United States
(12) Patent Application Publication
(10) Pub. No.: US 2010/0135024 A1
(43) Pub. Date: Jun. 3, 2010

(54) Decorative light protection device with environmental impact reduction features

(76) Inventors: Robert A. Gier, Barrington, IL (US); Andrew S. Gier, Barrington, IL (US); Michael D. Chan, Barrington, IL (US); Alex C. Clement, Barrington, IL (US)

Correspondence Address: Meroni & Meroni, P.C., P.O. Box 309, Barrington, IL, 60011, US

(21) Appl. No.: 12/592,664

(22) Filed: Dec. 1, 2009

Related U.S. Application Data
(60) Provisional application No. 61/200,666, filed on Dec. 2, 2008.

(51) Int. Cl. F21V 29/00; F21V 3/00

(52) U.S. Cl. 362/294; 362/311.01

(57) ABSTRACT

A decorative lighting assembly preferably comprises a shell assembly for use in combination with a lamp assembly having conductors and a lamp in electrical communication with said conductors intermediate the length thereof. The shell assembly comprises two shells, of which at least a portion is translucent or light-filtering. The shells each comprise an interior shell surface, an exterior shell surface, and cooperative shell fasteners. The fasteners fasten the shells together, and thereby the interior shell surfaces define a lamp-housing interior space. Opposed shell ends define conductor-letting apertures through which the conductors extend. The lamp is housed within the interior space. The conductors deliver power to the lamp, and the lamp, when powered, radiates light observable at the exterior shell surface(s) via the light-filtering material. Certain light refractive structures and glow in the dark elements may be added to enhance the assembly.

### PRIOR HISTORY

This application claims the benefit of provisional U.S. Patent Application No. 61/200,666, filed in the United States Patent and Trademark Office on Dec. 2, 2008.

### BACKGROUND OF THE INVENTION

1. Field of the Invention

This present invention generally relates to the field of decorative lighting and more particularly to decorative and protective shells placed on holiday light strings and nets that reduce the overall environmental impact of the decorative holiday light strings and nets.

2. Description of Prior Art

The prior art relating to decorative lighting and the like is fairly well developed. Some of the more pertinent prior art relating to decorative lighting, decorative devices and/or methods relating thereto are briefly described hereinafter. U.S. Pat. No. 4,234,915 ('915 patent), which issued to Malinowski, et al., for example, discloses an Ornamental Attachment for Decorative Light String. The '915 patent describes an ornamental structure for decorative string sets utilizing miniature and subminiature lamps in which a seamless ornament is securely fastened about the lamp and wires to provide both a decorative and strengthening function. It is noted that the '915 patent shows a protective bulb that is perpendicular to the light string and therefore more likely to snag.

It is believed that the present invention improves upon this prior art in that the shells according to the present invention are streamlined and attached in the line of the wire thereby reducing snagging tendency. Further, the present invention uses a wire securing device that binds to the wire using a strain relief mechanism that is able to resist greater forces than the friction method of the noted patent. Because the present invention secures the protective shell to the wire and not to the lamp it is able to transfer damaging forces away from the lamp and on to the wire. In other words, this prior art provides for protective shell that attaches directly to the lamp and thus will transfer damaging forces to the lamp. Further, it is noted that this prior art provides for a protective shell with no air vents, which will result in a buildup of heat near the lamp thus shortening its useful life. The present invention, by contrast comprises air vents which will reduce the temperature adjacent to the lamp thereby prolonging the useful life of the light string.

U.S. Pat. No. 5,021,935 ('935 patent), which issued to Gary, discloses a Decorative Light Shade. The '935 patent describes a decorative light shade assembly in the form of a hot air balloon comprising first and second releasably engageable shade sections injection molded from a polymeric material. At least one of the shade sections further comprises means for receiving a decorative bulb and socket assembly and means for frictionally engaging the electrical conductor connected to the decorative bulb and socket assembly for suspending the decorative light shade from the decorative light string. The use of molded apertures for directing light outwardly from the subject decorative light shade is also disclosed.

The present invention improves upon this prior art in that the decorative shell according to the present invention is in line with the wire and therefore is less susceptible to snagging. The present invention further improves upon this prior art in that the prior art relies on friction to affix the shade to the lamp. The present invention uses a wire securing device that binds to the wire using a strain relief mechanism that is able to resist greater forces than the friction method of the patent. Because the present invention secures the protective shell to the wire and not to the lamp it is able to transfer damaging forces away from the lamp and on to the wire. In other words, the Decorative Light Shade of the '935 patent will transfer damaging forces to the lamp, thereby reducing the effectiveness of said shade.

U.S. Pat. No. 5,214,903 ('903 patent), which issued to Chen et al., discloses a Method for the Packing of Decorative Lighting Strings and the Structure of Package Means. The '903 patent describes certain methodology comprising the step(s) of forming an intermediate section of conductor wire between each pair of adjacent light bulbs into an independent loop and hiding under the unutilized space available behind the light bulbs where a stacking rack is optionally provided so that the space originally required to accommodate the conductor wire in the aisle between two parallel rows of string stored can be substantially reduced.

The '903 patent further describes the structure of the package developed based upon said method as well as certain fastening means for steadily stacking up or extending sidewise said packages. The present invention improves upon the this art in that it removes the need for a protective outer carton as the shell according to the present invention provides a protective function otherwise provided by the packaging of this prior art. The present invention also improves on this prior art in that the protective function of the shell is provided throughout the entire life of the product not just in the period of the transport of the product from the manufacturer to the consumer.

U.S. Pat. No. 5,410,460 ('460 patent), which issued to Liou, discloses a Positioning Device for a String of Decorative Lights. The '460 patent describes a device comprising a plurality of lamp sockets, of which each is mounted with a decorative casing. The decorative casing includes a reflecting shade and a transparent shade. The center of the reflecting shade has a plug hole for receiving the lamp socket mounted with a spun-wire cable. The reflecting shade and the transparent shade can be assembled together by means of several fastening assemblies.

The ring flanges of the reflecting shade and the transparent shade are furnished with at least two symmetrical positioning hooks, of which each includes an opening, a guide slot and a positioning slot for receiving two single wires respectively extended out of the lamp socket. The lamp socket is clamped by means of the spun-wire cable so as to have the decorative casing positioned in a direction desired without swinging or overhanging at random; further, the wires extended out of the lamp socket will be retained in the positioning hooks to have the transparent shade positioned in a direction desired without being separated from the reflecting shade.

The present invention improves upon this prior art in that the decorative shell according to the present invention is in line with the wire and therefore is less susceptible to snagging. The present invention further improves upon the disclosure set forth in the '460 patent in that the shell is connected directly to the lamp. This will transfer damaging forces directly to the lamp. The present invention uses a wire securing device that binds to the wire using a strain relief mechanism and allows the lamp to float freely inside the shell. Because the present invention secures the protective shell to the wire and not to the lamp it is able to transfer damaging forces away from the lamp and on to the wire.

Furthermore, the device of the '460 patent does not comprise air vents. The lack of air vents allows heat to build up and will shorten the useful life of the light string. The present invention, by contrast, comprises air vents and will prevent heat buildup thereby lengthening the useful life of the light string. Still further, it is noted that the device of the '460 patent is relatively difficult to assemble as compared to the present invention. Further still, this prior art shows a device in which wires are bent at sharp angles. This may cause a break in the wire and reduce the useful life of the light string.

U.S. Pat. No. 5,548,493 ('493 patent), which issued to Young, discloses certain Phosphorescent Light Collars. The '493 patent describes a collar for an ornamental light bulb in which the collar contains a phosphorescent material such that the light bulb emits light into the collar and stimulates the phosphorescent material within the collar to emit light. In a preferred embodiment, the phosphorescent material is combined with a florescent dye to produce a miniature light collar containing a phosphorescent-florescent dye. Preferably, the collar comprises a low density polyethylene to promote flexibility of the collar to enable to fit over miniature bulbs of varying sizes.

The present invention improves upon this prior art in that it uses light filtering compounds to produce a more aesthetically pleasing light than that produced by the prior art. Further, it is noted that the prior art collar of the '493 patent attaches directly to the lamp and will therefore does not possess the ability of the invention to transfer damaging forces away from the lamp and onto the wire.

U.S. Pat. No. 5,997,992 ('992 patent), which issued to Paul, discloses Luminescent Cards and Decorative Items and Method of Manufacturing Luminescent Cards and Decorative Lights. The '992 patent describes a decorative item comprising a number of components which cooperate together. A layer of luminescent material is provided and is preferably, but not necessarily, a substantially rigid and planar carrier. A translucent image is affixed to the layer of luminescent material.

The decorative item is operable in a plurality of modes of operation, including an excitation mode of operation and a delayed light emission mode of operation. During the excitation mode of operation, the decorative item is exposed to a source of exciting energy, such as light. In the delayed light emission mode of operation, the layer of luminescent material generates a phosphorescent light emission, after the source of exciting energy is removed, which passes through the translucent image and makes it visible in low light conditions.

The present invention improves upon this prior art in that it uses light filtering compounds to produce a more aesthetically pleasing light than that produced by the prior art. It is further noted that this prior art does not possess the ability to transfer lamp-damaging forces away from the lamp and onto the wire.

U.S. Pat. No. 6,299,332 ('332 patent), which issued to Huang, discloses a Christmas Lamp Shell. The '332 patent describes a Christmas lamp comprising a number of lamp units, each of which has an ornamental shell part and bulb. The ornamental shell parts are made to have various shapes, e.g. tree shapes, animal shapes, star shapes and spiral shell shapes. The bulbs are each received in a corresponding one of the ornamental shell parts with a lead passed through two end holes.

The present invention improves upon this prior art in that the invention uses a wire securing device that acts as a strain relief mechanism and is able to transfer lamp damaging forces away from the lamp and on to the wire. In the prior art damaging forces would cause the shell to slide into the lamp and allow the lamp to be damaged. Further, the prior art lamp does not have air vents; this will allow heat to build up and will shorten the useful life of the light string. The present invention comprises air vents and will prevent heat buildup thereby lengthening the useful life of the light string. Further, it appears that this prior art lamp is relatively more difficult to assemble than the present invention. In this regard, it is noted that the prior art lamp does not provide a latch mechanism to allow the consumer to change shells according to the season/holiday.

The prior art also shows shells that are much larger than necessary to contain the lamp and they are therefore more harmful to the environment. The prior art does not contain a flat surface that can be easily manipulated by an automated assembly machine. The prior art does not provide means by which glow in the dark decorations may be added to the shell. The prior art does not have a mechanism to adjust for variation in the dimensions of the electric wire. The shell in the prior art has sharp edges that could potentially damage the insulation of the electric wire. The shells of the prior art are not mirror images of one another therefore the manufacturing cost is increased. The prior art does not have an option for glow in the dark shells which eliminates the need for wiring.

U.S. Pat. No. 6,196,701 ('701 patent), and U.S. Pat. No. 7,080,926 ('926 patent), both of which issued to Chang, describe lamps contained within a chain shaped decorative light string in which the chain link shell covers almost all of the wire of the decoration. This leads to a substantially heavier decoration that is more difficult to install. The heavier prior art decoration will also be more harmful to the environment due to the increased use of plastic.

The prior art decoration attaches the protective shell directly to the lamp and is more likely to transfer lamp damaging forces to the lamp. The prior art decoration requires bending wires at severe angles which may damage the wire connection to the lamp. The prior art requires threading the wires through a complex path. The present invention has a simpler path and is therefore easier to assemble. The prior art is restricted to only a chain shape to cover the lamps. The present invention is flexible and allows the consumer to change the shape and color of the shell covering the lamps. The prior art does not have any design features which will refract the light and cause it to sparkle. The present invention contains refractive facets and texturing of the inside surface which will provide a more sparkling light appearance.

U.S. Pat. No. 6,739,745 ('745 patent), which issued to Valdes, discloses Internally Illuminated Holiday Garland. The '745 patent describes icicle lights used for holiday decorating on the exterior of a home. The internally illuminated holiday garland is similar to conventional icicle lights with the exception of a white garland covering that is provided over the center fiber optic strand. The internally illuminated holiday garland is applied to the building or home in the same manner as conventional icicle lights, and provides a unique look both at night and during the day as well. During the day, the white garland forms a unique trim item that mimics the general appearance of snow and helps to hide the wiring. At night, the garland provides a reflective material from which the light from the lamps will reflect to provide a shimmering effect. The use of the internally illuminated holiday garland allows for exterior holiday decorating in a manner, which is unique and eye catching both at night and during the day as well. The present invention improves upon this prior art in that the glow in the dark shells according to the present invention do not require energy from lamps if placed outside. This eliminates the need for wiring to lamps.

U.S. Pat. No. 7,257,551 ('551 patent), which issued to Oskorep, et al., discloses Year-Round Decorative Lights with Selectable Holiday Color Schemes and Associated Methods. The '551 patent describes a decorative light strand having user-selectable color schemes corresponding to each holiday for year-round use. In one illustrative embodiment, the light strand has a plurality of lights; a decorating selector comprising a switch which provides a plurality of user-selectable settings; and logic coupled to the switch and the plurality of lights to provide different holiday color schemes in response to the user-selectable settings.

The present invention improves upon this prior art in that it allows for different seasons by allowing the consumer to interchange the seasonal shells. This allows the consumer to change both the shape and the color of the light. The prior art requires more lamps and wiring than the invention so the prior art is therefore more harmful to the environment. Also the larger number of lamps in the prior art make it heavier and more difficult to install than the invention. The complexity of the prior art make it more susceptible to failure thereby causing an increased damage to the environment due to more frequent and higher weight of product disposed.

U.S. Design Pat. No. D440,674, which issued to Nichols, discloses a Decorative Light String, which patent shows ornamental designs for a bulb-encasing football, a bulb-encasing football helmet, a bulb-encasing baseball cap, and a bulb-encasing basketball. The present invention improves upon these designs by having the decorative shell in line with the wire thereby reducing snagging.

U.S. Design Pat. No. D337,836, which issued to Johnson, an Ornamental Lighting Display. This design patent shows ornamental designs for the cars of a train hung from a decorative light string. The present invention improves upon these designs by having the decorative shell in line with the wire for reducing snagging tendency. The present invention also improves upon the prior art in that it uses streamlined shapes that are less likely to snag during installation and un-installation.

U.S. Design Pat. No. D374,293, which issued to Streger, et al., discloses Race Car Awning/Patio Lights. This design patent shows ornamental designs for a race car hung from a decorative light string. The present invention improves upon these designs by having the decorative shell in line with the wire thereby reducing snagging tendency.

U.S. Design Pat. No. D411,319, which issued to Baker, discloses an Ornamental Light String. This design patent shows various ornamental racing related shapes hung from a decorative light string. The present invention improves upon these designs by having the decorative shell in line with the wire thereby reducing snagging tendency. The present invention also improves upon the prior art in that it uses streamlined shapes that are less likely to snag during installation and un-installation.

U.S. Design Pat. No. D594,605, which issued to DeLuco, et al., discloses an Animal Leash. This patent shows an ornamental design of a leash with football decorations. The present invention improves on the prior art in that the design is applied to decorative light strings, and the invention shows laces on both sides of the ball.

From a review and consideration of the prior art, it will be noted the prior art does not provide decorative lighting assemblies comprising certain means for directing lamp-damaging forces away from the lamp structures. Further, it will be noted that the prior art does not provide decorative lighting assemblies that produce more aesthetically pleasing light by refracting and filtering light; that reduce the environmental impact by using glow in the dark inserts that allow a lower electrical power consumption and can eliminate the need for wiring; that transfer the protective function from the exterior packaging to the decorative shells enabling the lamp to be protected throughout its life; that reduce manufacturing costs through a shell that is easier to manufacture, handle and assemble; that provide a decorative shell that is more easy to change for different holidays; that reduce snagging tendencies making the light string more easy to install and take down; that improve safety by eliminating sharp edges that can damage the insulation of electrical wiring; and that reduce fire hazards by isolating the bulb from dry tree branches and venting to reduce temperature build up. The prior art thus perceives a need for such a decorative lighting assembly, as described in more detail hereinafter.

### SUMMARY OF THE INVENTION

It is the object of the invention to extend the useful life of decorative lights thereby reducing the adverse impact on the environment. It is a further object of the invention to reduce the impact on the environment of decorative light strings, by reducing the amount of packaging material required, reducing the consumption of electricity, and reducing the amount of electrical wiring required. It is a further object of the invention to reduce copper wire waste by providing strain relieve means that secure copper wire with a minimum of copper wire being used. It is a further object of the invention to reduce the consumer's time to install and un-install decorative lights.

It is a further object of the invention to reduce time and cost to assemble decorative light strings during the manufacturing process by providing a surface for automatic assembly, simplifying the wire attachment process, providing a nestable shell that requires less storage space, and reducing the number of parts required. It is a further object of the invention to reduce the risk of fire. It is a further object of the invention to produce light that is more aesthetically appealing. It is a further object of the invention to reduce the risk of electrical shock. It is a further object of the invention to provide a decorative and protective shell that is robust to the variation in light string dimensions and can be applied to strings from multiple vendors.

The achieve these objectives, the present invention provides a decorative lighting assembly for use in combination with a lamp assembly having power delivery conductors and a lamp in electrical communication with said conductors intermediate the length thereof. The shell assembly comprises first and second shells, each of which preferably comprise certain light filtering or translucent material for enabling light from the shell-enclosed lamp to pass therethrough. Alternatively, the material construction of the shells may include or otherwise be defined by glow in the dark type material.

The shells each further comprise opposed shell ends, a longitudinal shell length, an interior shell surface, an exterior shell surface, and cooperative shell fastening means. The shell fastening means essentially function to fasten the shells together. When so fastened, the interior shell surfaces define a lamp-housing or lamp-enclosing interior space, and the opposed shell ends define conductor-letting apertures. The conductors of the lamp assembly or light string extend through the conductor-letting apertures, and the lamp is housed or enclosed within the interior space. The conductors deliver power to the lamp, and when powered, the lamp radiates light observable via the light-filtering material construction of the shells.

The decorative lighting assembly further comprises certain tension-reducing, wire-securing means attached to a select interior shell surface, which means are cooperable with the conductors for reducing tension within the conductors at the site of electrical communication with the lamp for enhancing safety of the decorative lighting assembly. Further, either or both of the shells may preferably comprise air vents for venting heated air from the interior space and for enhancing safety of the decorative lighting assembly.

It is contemplated that the preferred embodiment of the decorative light-protective shell assembly may be formed or shaped such that the shells are tapered from a point intermediate the longitudinal shell length toward the opposed shell ends as would by the general case with a football type construction. Thus, the tapered shells may well function to reduce snagging tendencies and for enhancing the overall safety of the decorative lighting assembly.

Further, the decorative lighting assembly may preferably comprise certain optical means for enhancing the visual appearance of the shell assemblies. In this regard, it is contemplated that select shell surfaces may be provided or otherwise outfitted with light refractive elements for enhancing the appearance of the light otherwise observable via the light-filtering material. Further, the decorative lighting assembly may comprise certain glow in the dark materials and/or elements for enhancing the appearance of the decorative lighting assembly when the lamp is deprived of light-enabling power or is subject to low light conditions.

### BRIEF DESCRIPTION OF THE DRAWINGS

Other features of our invention will become more evident from a consideration of the following brief description of patent drawings:

FIG. 1 is a perspective view of a string of first examples of three assembled shell assemblies according to the present invention as axially aligned and outfitted upon a fragmentary decorative light string.

FIG. 2 is a top plan view of a first example of an assembled shell assembly according to the present invention as outfitted upon a fragmentary decorative light string.

FIG. 3 is a front plan view of second examples of four assembled shell assemblies highlighting a streamlined shape as outfitted upon a fragmentary decorative light string.

FIG. 4 is top perspective view of a bottom portion of the first example of the shell assembly according to the present invention as outfitted upon a fragmentary decorative light string with a top shell removed from the shell assembly to show otherwise hidden structure, including post type wire securing structures.

FIG. 5 is a top plan view of the structures otherwise depicted in FIG. 4 demonstrating post type wire securing structures with preferred cooperative latch mechanisms shown intermediate the length of the bottom portion.

FIG. 6 is top perspective view of a bottom portion of the third example of the shell assembly according to the present invention as outfitted upon a fragmentary decorative light string with a top shell removed from the shell assembly to show otherwise hidden structure, including hook type wire securing structures.

FIG. 7 is top perspective view of a bottom portion of the fourth example of the shell assembly according to the present invention as outfitted upon a fragmentary decorative light string with a top shell removed from the shell assembly to show otherwise hidden structure, including clip type wire securing structures.

FIG. 8 is a top plan view of the structures otherwise depicted in FIG. 7 demonstrating clip type wire securing structures with preferred cooperative latch mechanisms shown intermediate the length of the bottom portion.

FIG. 9 is a side plan of a first example of an assembled shell assembly according to the present invention as outfitted upon a fragmentary decorative light string showing top and bottom portions or shells of the shell assembly.

FIG. 10 is a transverse sectional view as sectioned along plane A-A of FIG. 9 demonstrating post type wire securing structures with preferred cooperative latch mechanisms shown intermediate the length of the top and bottom portions or shells.

FIG. 11 is a transverse sectional view as sectioned along plane A-A of FIG. 9 demonstrating clip type wire securing structures with preferred cooperative latch mechanisms shown intermediate the length of the top and bottom portions or shells.

FIG. 12 is a fragmentary enlarged view of Box C as taken from FIGS. 10 and 11 showing the preferred cooperative latch mechanisms.

FIG. 13 is a longitudinal sectional view of a fifth example of the shell assembly according to the present invention as outfitted upon a fragmentary decorative light string and depicting inner refractive facets, outer glow in the dark material and spring board type wire securing structures.

FIG. 14 is a transverse sectional view as sectioned along plane D-D of FIG. 13 showing inner refractive facets and outer glow in the dark material.

FIG. 15 is a longitudinal sectional view of a sixth example of the shell assembly according to the present invention as outfitted upon a fragmentary decorative light string and depicting inner refractive surface texturing, a glow in the dark insert with lettered indicia, and spring board type wire securing structures.

FIG. 16 is a transverse sectional view as sectioned along plane E-E of FIG. 15 showing inner refractive surface texturing and a glow in the dark insert.

FIG. 17 is a top plan view of a seventh example of the shell assembly according to the present invention as outfitted upon a fragmentary decorative light string showing external glow in the dark inserts and alternative latch mechanisms in the end position(s).

FIG. 18 is a top plan view of an eighth example of the shell assembly according to the present invention as outfitted upon a fragmentary decorative light string showing internal glow in the dark inserts and alternative latch mechanisms in the end position(s).

FIG. 19 is an enlarged end view of the Box F as taken from FIG. 17 showing an alternative latch mechanism in the end position with male and female snaps in horizontal orientation.

FIG. 20 is an enlarged, fragmentary end view of the Box G as taken from FIG. 18 showing an alternative latch mechanism in the end position with male and female snaps in vertical orientation after assembly.

FIG. 21 is an enlarged, fragmentary front view of the Box G as taken from FIG. 18 showing an alternative latch mechanism in end position with male and female snaps in vertical orientation prior to assembly.

FIG. 22 is an enlarged, fragmentary front view of the Box G as taken from FIG. 18 showing an alternative latch mechanism in end position with male and female snaps in vertical orientation after assembly.

FIG. 23 is a front plan view of a ninth shell assembly according to the present invention shown hanging from a branch with an internal glow in the dark insert and a lighter filtering outer shell.

FIG. 24 is a front plan view of a tenth shell assembly according to the present invention shown with hook means for hanging the shell assembly from a support structure and an external glow in the dark material.

### DESCRIPTION OF THE PREFERRED EMBODIMENT

Referring now to the drawings with more specificity, the preferred embodiment of the present invention essentially provides a decorative light protection device or decorative light-protecting shell assembly as generally depicted at 13. The decorative light (or lamp) protection device or assembly 13 according to the present invention preferably comprises a top or first shell as at 5 and a bottom or second shell as at 6. The first and second or top and bottom shells 5 and 6 are preferably identical to each other in form and function so as to reduce production costs insofar as a single mold may be made to form each of the shells 5 and 6.

Each of the shells 5 and 6 is preferably constructed from or comprises a decorative, light-filtering or translucent or similar other optical material for allowing light to pass from a shell enclosed lamp 7 onto the interior shell surface 30 and through the material so as to be visibly observable at the exterior shell surface 31. Alternatively, the material construction of the shells 5 and 6 may include or otherwise be defined by glow in the dark type optical material.

Each shell 5 and 6 further comprises air vents as generally depicted at 2; certain shell fastening means for cooperably fastening shells 5 and 6 to one another as exemplified by a latch mechanism as at 3; various and certain means for reducing tension along or within the wires/conductors of a lamp assembly; certain means for refracting light emanating from a shell-enclosed lamp assembly; and glow in the dark inserts or attachments as at 14.

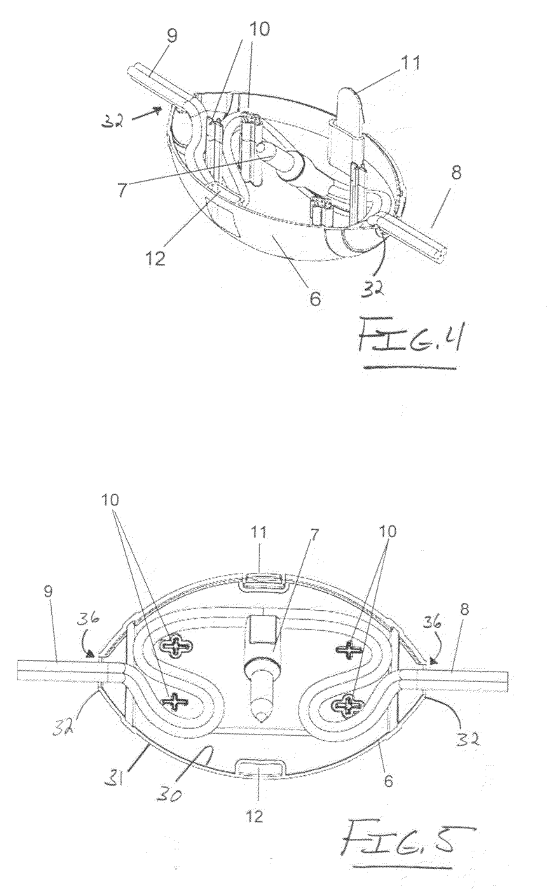

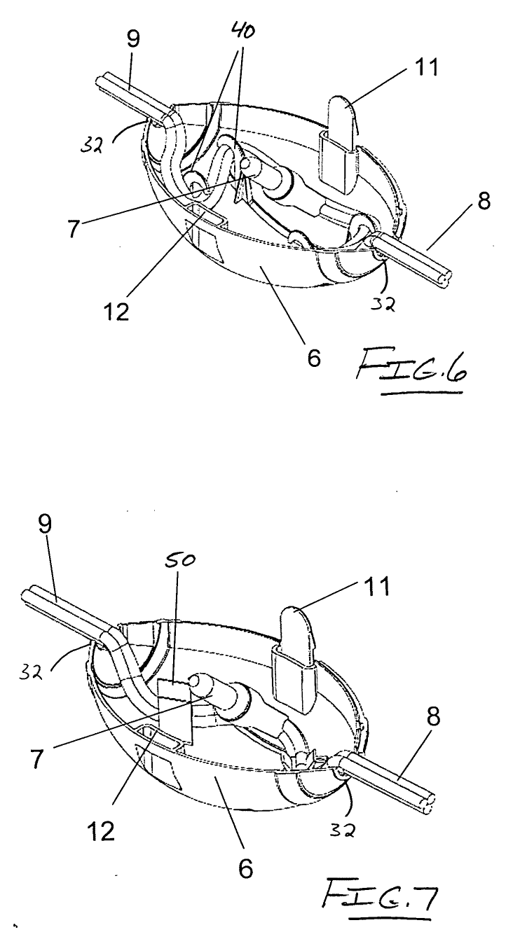

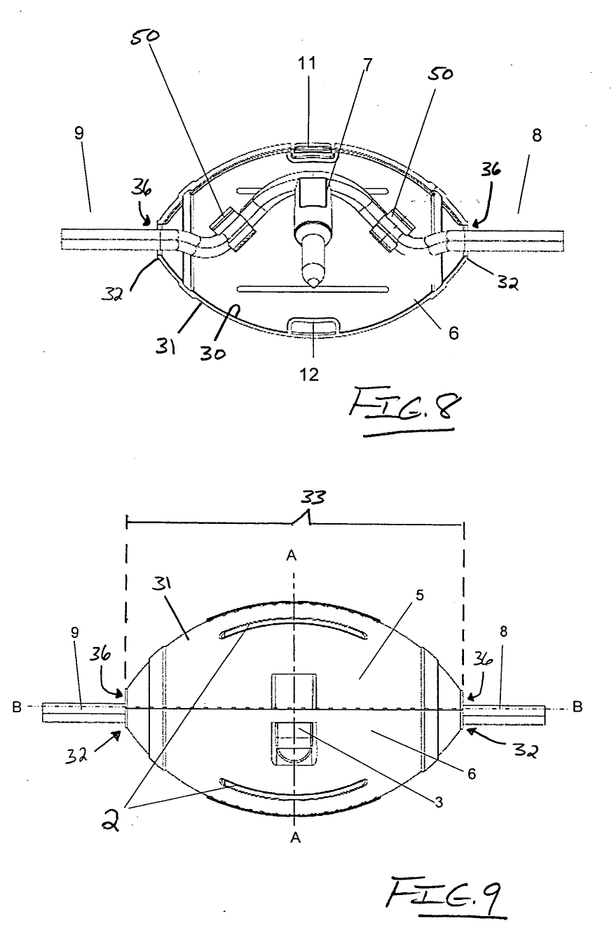

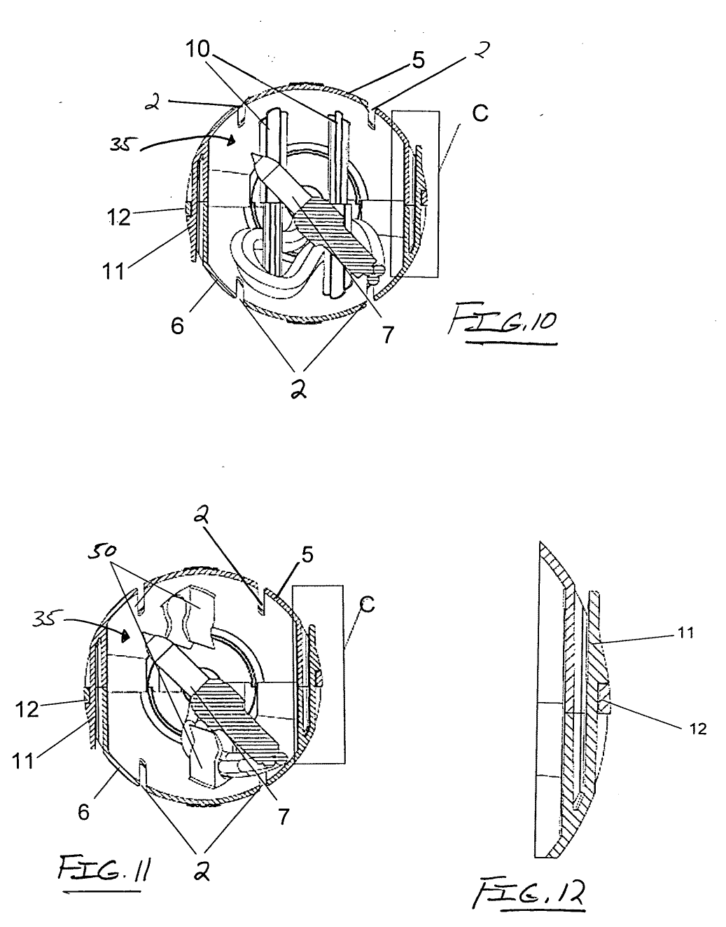

An auto assembly tab 1 may be implemented as part of the surface of the air vents 2, or as the surface of the latch mechanism 3. The latch mechanism 3 preferably comprises a male snap 11 and a female snap 12. The latch mechanism 3 may be implemented in various locations along the perimeter of the shells 5 or 6. In this regard, it should be noted that the latch mechanism 3 may be implemented on the ends, on the midpoint or points in between. Further, the latch mechanism 3 may be implemented with the male and female portions generally projecting either in the vertical direction as generally depicted in FIGS. 4-12 or in the horizontal direction as generally depicted in FIG. 19.

The means for reducing tension along or within the wires/conductors of a lamp assembly may be exemplified by certain wire securing devices that interface with the entry wire 8 and exit wire 9 of the decorative light or lamp assembly 7. The wire securing devices may be implemented in various configurations such as a vertical post type constructions as at 10, hook type constructions as at 40, clip type constructions as at 50, or spring board type constructions as at 23. It is contemplated that the spring board type constructions 23 interlock with one another when the latch mechanism 3 is closed and they come in contact with the stop 22.

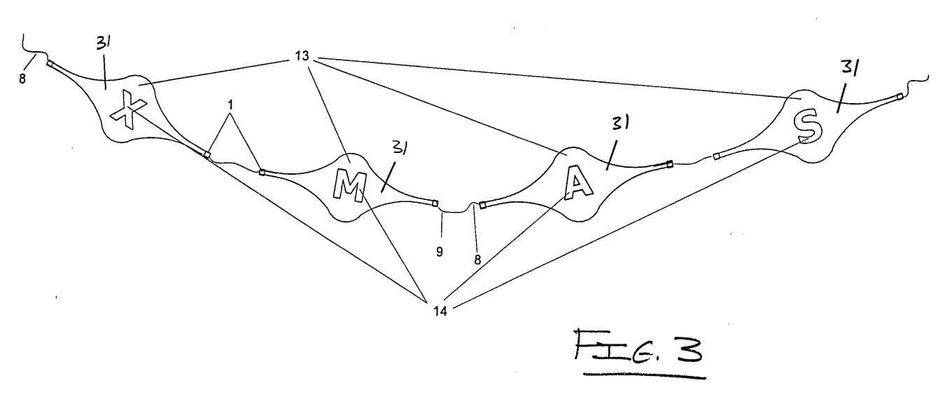

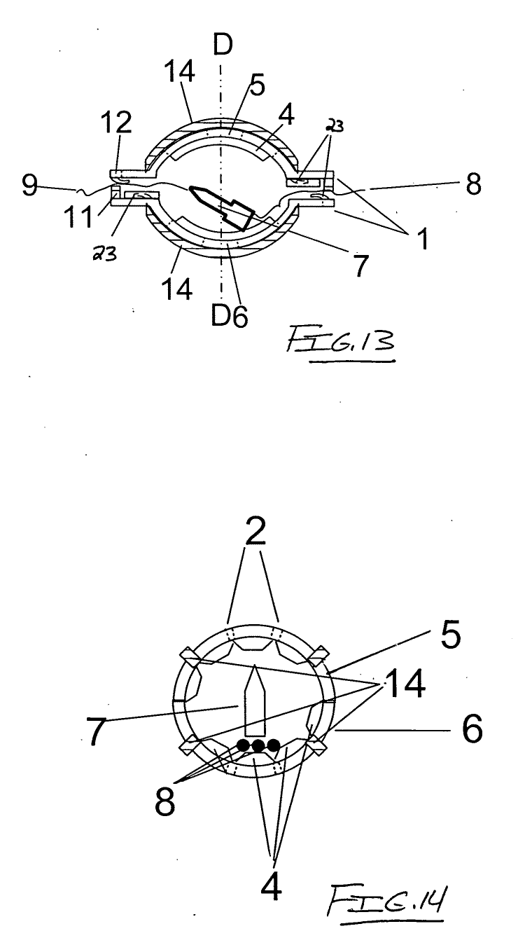

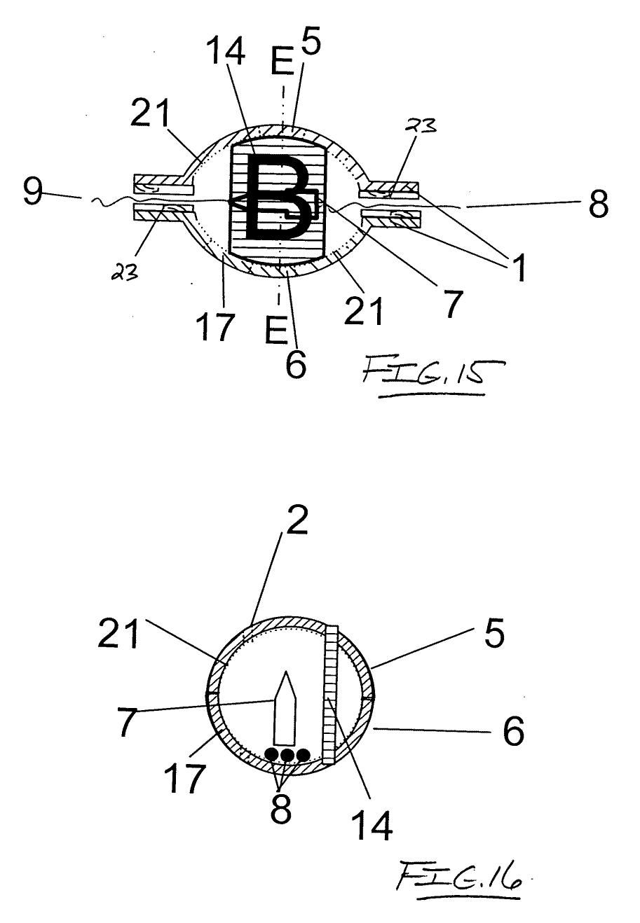

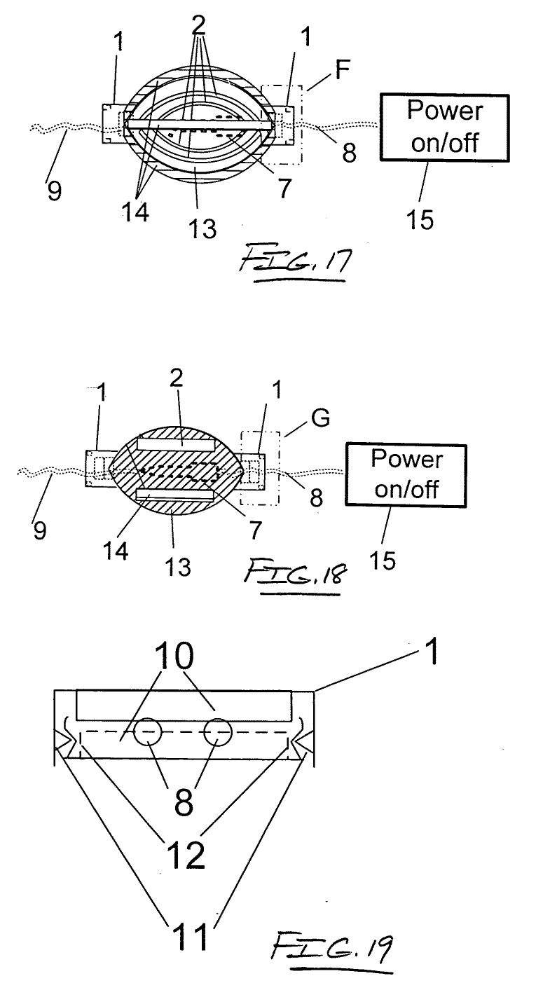

A glow in the dark insert or attachment 14 may be preferably attached to the upper and/or lower shells 5 and 6. The glow in the dark insert or attachment 14 may be in the shape of the outline of the shell 5 and 6 as generally depicted in FIGS. 13 and 14, or as indicia born upon certain structure, which indicia are the form of alphanumeric symbols as generally depicted in FIGS. 3 and 15; or other decorative symbols or forms. The glow in the dark insert or attachment 14 may be placed inside the shell (as generally depicted in FIGS. 15, 16, and 23) or on the shell's exterior surface (as generally depicted in FIGS. 13, 14, and 24).

It is contemplated that sunlight or other light source may provide energy to the glow in the dark insert or attachment 14. Alternatively the power on-off mechanism 15 can allow the decorative light or lamp assembly 7 to illuminate and provide energy to the glow in the dark insert or attachment 14. Alternatively glow in the dark material may be molded into the top and bottom shells 5 and 6. Light filter material 17 may be molded into the top and bottom shells 5 and 6.

The user places a top or second shell 6 above and bottom or first shell 5 below the decorative light or lamp assembly 7. The wire or conductors 8 and/or 9 is fed into or otherwise cooperatively associated the wire securing devices or means for reducing tension in the wires/conductors. The female snap 12 is snapped into the male snap 11. The user may then slide the glow in the dark insert 14 into the vent hole 2 and it snaps in place. In this regard, it is contemplated that the glow in the dark insert 14 further provides certain connective structure between the top and bottom shells 5 and 6, and allows the shells 5 and 6 to remain connected when impacted by opposing forces of tree branches and other items encountered during installation.

Once the top and bottom shells 5 and 6 are snapped in place, the wire securing devices place the shells 5 and 6 into contact the wires/conductors. Any force that would normally act on the decorative light string during storage, installation or display and shorten its useful life is thus otherwise absorbed by the shells 5 and 6, or transferred away from the lamp. Any effect from natural elements during usage will be reduced because of the protective properties of the shells 5 and 6.

To improve or enhance the safety aspects of the assembly 13, the air vents 2 allow cooling of the light or lamp assembly 7 thereby further helping to maintain a longer useful life. The shells 5 and 6, in combination with the air vents 2, reduce the risk of fire by separating a dry tree branch from the hot lamp 7. Further, the exterior shell surfaces 31 preferably comprise no sharp edges. This prevents the shells 5 and 6 from snagging on things during assembly and installation. Elimination of sharp edges also prevents the damage of the electrical insulation on the entry and exit wires 8 ad 9. Elimination of sharp edges further reduces operator discomfort when assembling the shells 5 and 6. Additionally, the shells 5, 6 have the ability to stack; this reduces transportation and storage volume. As earlier noted, since the top shell 5 and bottom shell 6 are preferably identical, there is a reduction in the number of parts to handle.

The glow in the dark inserts or attachments 14 allows emission of light when the power is turned off thereby allowing power conservation. The glow in the dark inserts or attachments 14 can also be powered by sun light during the day and glow at night, eliminating the need for electric power, and the associated wiring. In the future, the glow in the dark elements 14 could eliminate the need for wiring and electrical power. In other words, the decorations would solely be illuminated by glow in the dark elements 14.

It is further contemplated that the light filtering or translucent material construction of the shells may be provided so as to adjust or otherwise affect the light emanating from the glow in the dark insert 14 to be more aesthetically pleasing. Further, certain means for refracting light emanating from the shell-enclosed lamp assembly 7 may be exemplified by refractive facets as at 4 and/or refractive textured surfacing as at 21. It is contemplated that the means for refracting light may well contribute to the aesthetic appeal of the assembly 13, in part, because it makes light appear to sparkle.

The bending and elastomeric properties of the spring board type constructions 23 enables said constructions to accommodate variations in the dimensions of wires/conductors 8 and 9. In the unassembled state the spring board type constructions 23 are slightly curved. When assembled, the spring board type constructions 23 are pressed against the stops 22. The stops 22 force the spring board type constructions 23 to straighten and results in a binding of the entry and exit wires 8 and 9. Also, the wire securing devices use minimal amounts of wire and allow for optimal spacing of the lights.

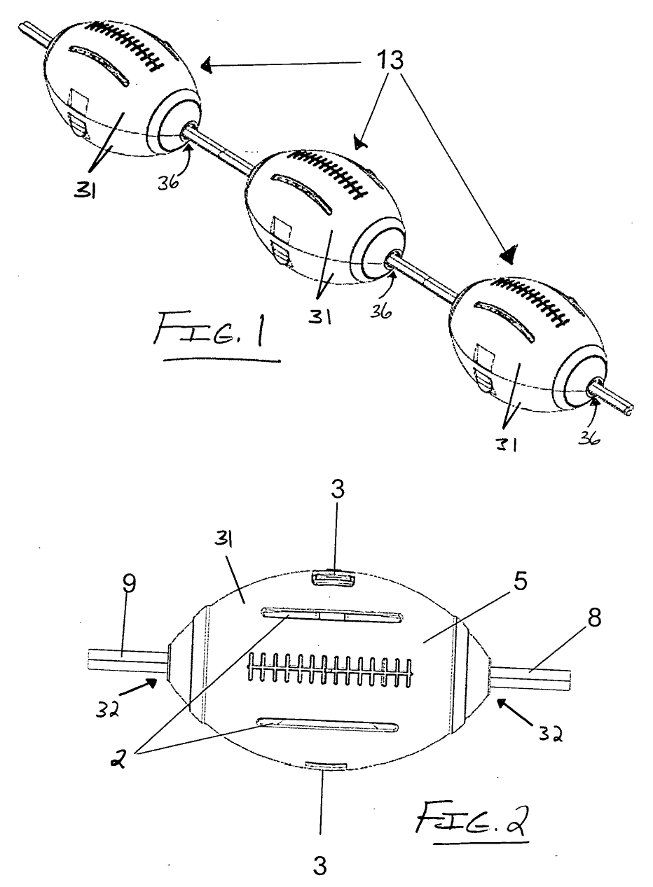

FIGS. 1 and 3 comparatively depict two of many possible streamlined shell assemblies 13 for the invention. Alternative embodiments for the shell assembly 13 include other streamlined shapes that allow the light string to be installed and uninstalled with less snagging and protect the decorative lamp from unwanted forces. The size of the shells 5 and 6 may be increased or decreased to accommodate smaller light source such as LED lamps or larger lamps.

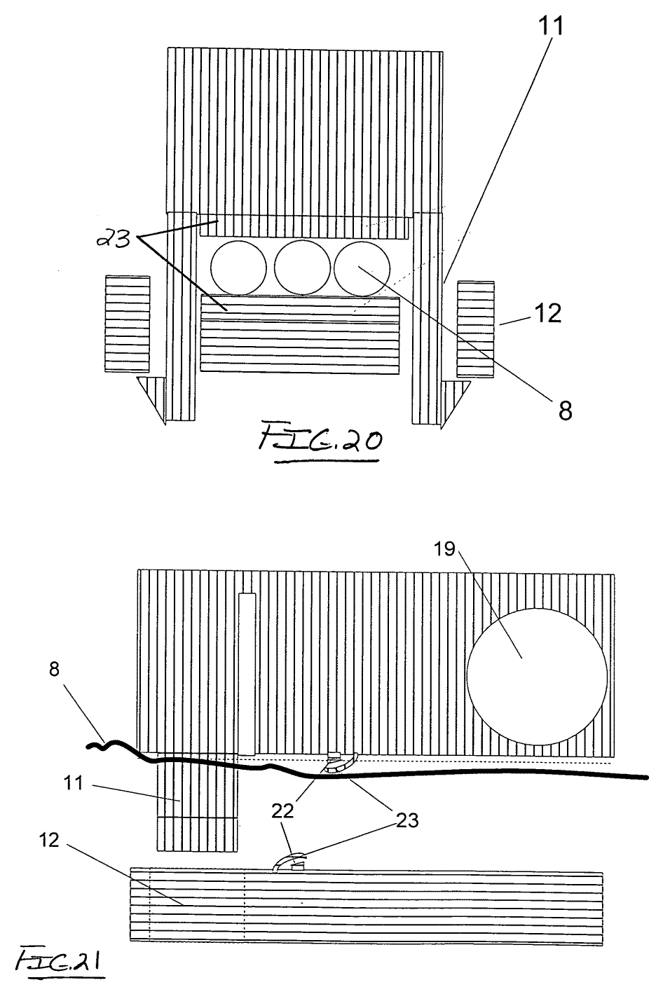

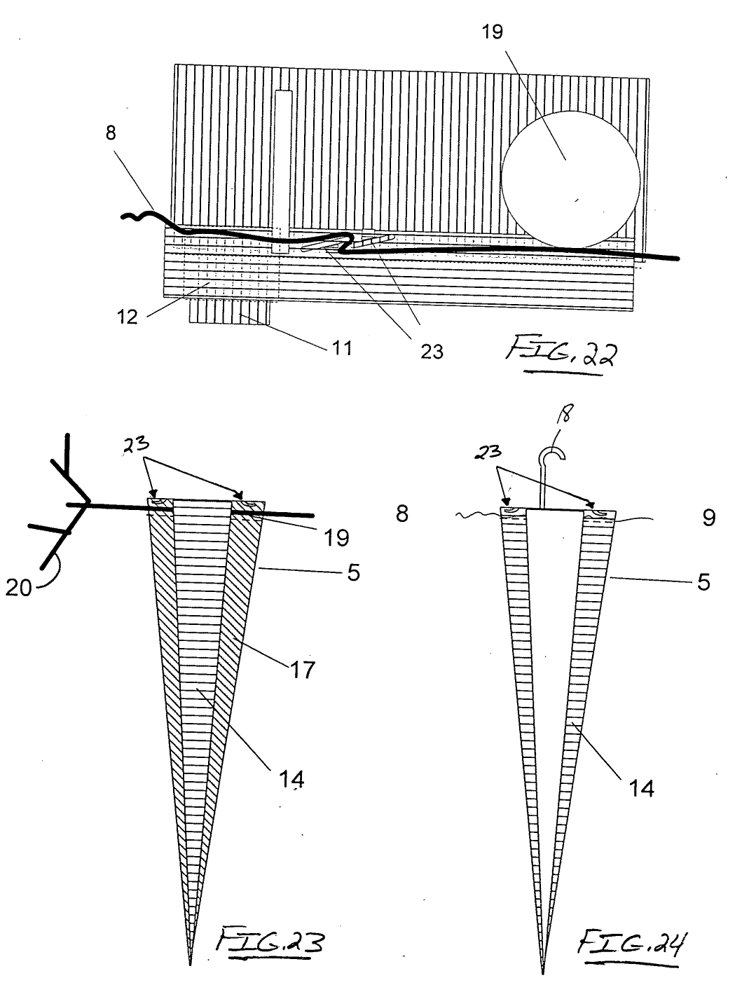

FIGS. 19-21 depict certain alternative embodiments for the latch mechanism 3 that holds the shells 5 and 6 securely to the wires 8 and 9, and does not open when impacted by a force, but allows the consumer to open the shell assembly 13 when desired. For example, an auto assembly tab 1 allows or enables the shells 5 and 6 to be quickly installed on a light string by providing simplified latch mechanism 3. Additional alternative embodiments of the invention not shown include other latch mechanisms that allow the consumer to easily open the shell and replace it with a different shell, but prevent the shell from opening when impacted by a force.

It will thus be seen that the present invention provides certain advantages as compared to the prior art: For example, the streamlined design of the shell assembly 13 reduces the snagging of the outfitted light string on tree branches and thereby reduces the installation and un-installation time for the consumer. Further, the decorative light string is less likely to become tangled with itself and it is less likely to catch on tree branches and other obstacles.

The shell protection device or shell assembly 13 further deflects damaging forces from the fragile lamp 7 and transfers them to the more durable wires/conductors 8 and 9 and housing as embodied by the shells 5 and 6. The protective shells are 5 and 6 are robust and can accommodate dimensional variance of wires. Further, the air vents 2 in the shells 5 and 6 disperse heat allowing the shell assembly 13 to be closer to the lamp 7 for reducing the amount of plastic required for the shell assembly 13 thereby reducing the overall environmental impact. The air vents 2 further allow cooling of the lamp 7 thereby tending to increase lamp life.

It is further contemplated that the shells 5 and 6 may well further provide a thermal barrier between outfitted lamps 7 and combustible materials to which the outfitted lamps are attached (e.g. dry Christmas tree branch(es) 20), thereby tending to reducing the risk of fire. It is further contemplated that the air vents 2 and select polymer construction of the shells 5 and 6 may well reduce the risk of the shells igniting.

Further, it is contemplated that the air vents, in combination with the elastomeric construction of the shells, may well provide certain shell flexibility allowing the shells to absorb impact forces. The glow in the dark material provides observable light in low light conditions thereby allowing electric current consumed by the lamp 7 to be reduced, either by relying solely on ambient material-energizing light or by pulsing current to the lamp or by placing fewer lamps per foot on the decorative light string. Notably, the electricity reduction benefits the environment.

Certain forms of the shells 5 and 6 may be made nestable thereby reducing the shipping volume for the shells themselves. The shell latching devices can be easily opened by the consumer to allow the consumer to change the shape or color of the shell to fit the season. The prior art packaging protects the lamp only during the transportation to the consumer's home. The invention improves upon prior art by moving the protective function from the packaging to the light string. This extends the protection of the lamp to include the multiple storage and installation cycles in the consumer's home.

As the shell provides the protective function, the need for extensive protective packaging is reduced. This allows the manufacture to use a package that has less adverse impact on the environment. As the light string is better protected it will have a longer life. This will reduced the environmental impact caused by disposal of non-functional light strings. The shell design has an auto assembly tab that allows easy manipulation by automated assembly equipment. The shell design has no sharp edges that would cause discomfort to the assembly operator or consumer's fingers or damage to electrical wire insulation.

The upper and lower shells are the same part rotated 180 degrees. This reduces the number of parts to be handled in the manufacturers supply chain thereby reducing overall product cost. When placed outside, the shells are exposed to sunlight and can glow after dark. This eliminates the need for electrical wiring and reduces the cost of exterior decorations and the time to install them. Glow in the dark elements provide a lower cost, lower energy consumption product that can be used to mark the edge of sidewalks and driveways. The light filtering material produces a more aesthetically appealing light than conventional glow in the dark material. The refractive facets and texturing of the shell assembly produce a light that is more aesthetically appealing.

While the foregoing descriptions set forth or contain much specificity, this specificity should not be construed as limitations on the scope of the invention, but rather as an exemplification of the invention. For example, it is contemplated that the present invention essentially provides a decorative lighting assembly, which decorative lighting assembly comprises, in combination, a lamp assembly and a shell assembly. In this regard, the lamp assembly is believed to essentially comprise certain power delivery conductors or wires as at 8 and 9, and a lamp or lamp assembly as at 7. Notable, the lamp 7 is in electrical communication with said conductors intermediate the length thereof as generally depicted in the drawings.

The shell assembly as at 13 preferably and essentially comprises first and second shells 5 and 6, each of which comprise or are constructed from certain light filtering material for enabling lamp light to pass therethrough. Further, each shell 5 and 6 comprises opposed shell ends as at 32, a longitudinal shell length as at 33, an interior shell surface as at 30, an exterior shell surface as at 31, and cooperative shell fastening means as preferably exemplified by the latch mechanism(s) 3.

The shell fastening means fasten the shells together such that together the interior shell surfaces 30 define a lamp-housing or lamp-enclosing interior space as at 35. The opposed shell ends 32 define conductor-letting apertures as at 36 such that when outfitted upon a light string, the conductors 8 and 9 extend through the conductor-letting apertures 36. The lamp 7 is housed within the interior space 35 and the conductors deliver power to the lamp 7. The lamp, when powered, radiates light, which light is observable via the light-filtering material construction of the shells 5 and 6.

The enhance the safety aspects of the decorative lighting assembly, the decorative lighting assembly may preferably further comprise certain tension-reducing, wire-securing means as exemplified by the wire securing devices set forth or otherwise incorporated herein. The wire-securing means are preferably attached to a select interior shell surface 30 and are cooperable with the conductors 8 and 9 for reducing tension within the conductors 8 and 9 at the site of electrical communication with the lamp 7 thereby enhancing safety of the decorative lighting assembly.

Items or elements 10, 40, 50, 22, and 23 respectively show post type constructions, hook type constructions, clip type constructions, stops, and spring board constructions 23 are but a few alternative embodiments for a device to hold the shells to the wires or otherwise connect the shells to the wires for transferring damaging forces away from the lamp assembly 7. It is contemplated that other alternative embodiments of the invention not shown may well include other devices that can adjust to variable wire diameters and hold the shells in place on the wire strand for reducing tension or other wire/assembly damaging forces away from the lamp assembly.

The shells of the decorative lighting assembly may further comprise certain air vents for venting heated air from the interior space 35. It is contemplated that the air vents may thus further enhance the safety aspects of the decorative lighting assembly. It is contemplated that the size and shape of the air vents 2 may be of virtually any size and shape so long as they achieve the form and function essentially described herein. Further, the shells may be streamlined or tapered from a point intermediate the longitudinal shell length 33 toward the opposed shell ends 32. In this regard, it is contemplated that the tapered shells 5 and 6 may well function to reduce snagging tendency for enhancing safety of the decorative lighting assembly.

The shell surfaces 30 and/or 31 may be outfitted or otherwise provided with certain means for refracting light passing through the material construction. In this regard, it is contemplated that the light refracting means may be exemplified by surface texturing (as at 21) or may be exemplified by light refractive facets (as at 4) for enhancing the appearance of the light otherwise observable via the light-filtering material construction of the shells 5 and 6. Further, certain glow in the dark material or elements may be outfitted upon or in connection with the shells 5 and 6 for enhancing the appearance of the decorative lighting assembly when the lamp is deprived of light-enabling power or is placed into low light conditions.

In this last regard, it is noted that elements 14 essentially show glow in the dark inserts or attachments that emit visible light after absorbing electromagnetic energy. It is contemplated that one alternative embodiment of the invention is to mold the glow in the dark material directly into the shells rather than placing it in separate inserts. It is further contemplated that a second alternative embodiments may go to inserts and/or attachments that are designed to be lines that follow the outline of the shells or they may also be symbols such as stars, icicles, or alphanumeric characters, or other decorative shapes.

FIGS. 1 and 3 generally depict protective shell assemblies 13 connected or otherwise outfitted upon a conventional decorative light string. An alternative embodiment is to place or outfit the shell assemblies 13 on a decorative light net or mesh rather than a string. Further, icicle type constructions, for example, may be more aesthetically appealing. In this regard, it is contemplated that the shells 5 and 6 be formed perpendicular to the axis of the wire/conductors. Thus, alternative embodiments of the invention would allow the top and bottom shells 5 and 6 to be attached to the entry wire 8 and exit wire 9 or the branch 20 in a manner that is perpendicular to the wire as generally depicted in FIGS. 23 and 24. For applications where no electric power is desired the top and bottom shells 5 and 6 may be molded as a single piece containing glow in the dark material with an added hook 18, or branch hole, 19.

Accordingly, although the invention has been described by reference to certain preferred and alternative embodiments, it is not intended that the novel disclosures herein presented be limited thereby, but that modifications thereof are intended to be included as falling within the broad scope and spirit of the foregoing disclosure, the following claims and the appended drawings.

We claim:

1. A decorative lighting assembly, the decorative lighting assembly comprising, in combination:
a lamp assembly, the lamp assembly comprising conductors and a lamp, the lamp being in electrical communication with said conductors intermediate the length thereof; and
a shell assembly, the shell assembly comprising first and second shells, each shell comprising light filtering material, each shell comprising opposed shell ends, a longitudinal shell length, an interior shell surface, an exterior shell surface, and cooperative shell fastening means, the shell fastening means fastening the shells together, the interior shell surfaces defining a lamp-housing interior space, the opposed shell ends defining conductor-letting apertures, the conductors extending through the conductor-letting apertures, the lamp being housed within the interior space, the conductors for delivering power to the lamp, the lamp, when powered, for radiating light, the light being observable at the exterior shell surfaces via the light-filtering material.

2. The decorative lighting assembly of claim 1 comprising tension-reducing, wire-securing means, the wire-securing means being attached to a select interior shell surface and being cooperable with the conductors for reducing tension within the conductors at the site of electrical communication with the lamp and for enhancing safety of the decorative lighting assembly.

3. The decorative lighting assembly of claim 2 wherein a select shell of the first and second shells comprises air vents, the air vents for venting heated air from the interior space and for enhancing safety of the decorative lighting assembly.

4. The decorative lighting assembly of claim 3 wherein the shells are tapered from a point intermediate the longitudinal shell lengths toward the opposed shell ends, the tapered shells for reducing snagging tendency and for enhancing safety of the decorative lighting assembly.

5. The decorative lighting assembly of claim 4 wherein a select shell surface of the interior and exterior shell surfaces is provided with refractive texturing for enhancing the appearance of the light otherwise observable via the light-filtering material.

6. The decorative lighting assembly of claim 4 wherein a select shell surface of the interior and exterior shell surfaces is outfitted with refractive facets for enhancing the appearance of the light otherwise observable via the light-filtering material.

7. The decorative lighting assembly of claim 4 comprising glow in the dark material for enhancing the appearance of the decorative lighting assembly when the lamp is deprived of light-enabling power.

8. A decorative, lamp-enclosing shell assembly for use in combination with a lamp assembly, the shell assembly comprising:
first and second shells, tension-reducing, conductor-securing means, and light filtering material, each shell comprising opposed shell ends, a longitudinal shell length, an interior shell surface, an exterior shell surface, and cooperative shell fastening means, the shell fastening means for fastening the shells together about a lamp assembly, the interior shell surfaces for defining a lamp-housing interior space, the opposed shell ends for defining conductor-letting apertures, conductors of a lamp assembly being extendable through the conductor-letting apertures, a lamp of a lamp assembly being housable within the interior space, the light-filtering material for letting light pass therethrough when power is conductor-delivered to the lamp as enclosed within the interior space, the conductor-securing means for reducing tensile forces within a shell-enclosed lamp assembly and for enhancing safety of the shell assembly.

9. The shell assembly of claim 8 wherein a select shell of the first and second shells comprises an air vent, the air vent for venting heated air from the interior space and for enhancing safety of the shell assembly.

10. The shell assembly of claim 8 wherein the shells are tapered from a point intermediate the longitudinal shell lengths toward the opposed shell ends, the tapered shells for reducing snagging tendency and thus for enhancing safety of the shell assembly.

11. The shell assembly of claim 8 wherein a select shell surface of the shell surfaces is provided with refractive texturing for enhancing the appearance of light otherwise observable via the light-filtering material.

12. The shell assembly of claim 8 wherein a select shell surface of the shell surfaces is outfitted with refractive facets for enhancing the appearance of light otherwise observable via the light-filtering material.

13. The shell assembly of claim 8 comprising glow in the dark material for enhancing the appearance of the shell assembly in low light conditions.

14. A decorative, lamp protective device, the decorative, lamp protective device comprising:
at least one lamp protective shell, each shell comprising opposed shell ends, a longitudinal shell length, an interior shell surface, an exterior shell surface, optical material, and means for fastening the shell adjacent a lamp, the opposed shell ends defining apertures, conductors of a lamp assembly being extendable through the apertures, a lamp of a lamp assembly being housable adjacent the interior shell surface, the optical material enabling light to emanate therefrom when power is conductor-delivered to the lamp as fastened adjacent the inner shell surface.

15. The device of claim 14 comprising tension-reducing, wire-securing means, the wire-securing means for reducing tensile forces attendant to the lamp assembly for enhancing safety of the device.

16. The device of claim 14 wherein the shell comprises an air vent, the air vent for venting heated air from the device for enhancing the safety thereof.

17. The device of claim 14 wherein the shell is tapered from a point intermediate the longitudinal shell length toward the opposed shell ends, the tapered shell for reducing snagging tendency and thus for enhancing safety of the device.

18. The device of claim 14 wherein a select shell surface of the shell surfaces is provided with refractive texturing for enhancing the appearance of light otherwise observable via the light-filtering material.

19. The device of claim 14 wherein a select shell surface of the shell surfaces is outfitted with refractive facets for enhancing the appearance of light otherwise observable via the light-filtering material.

20. The device of claim 14 comprising glow in the dark material for enhancing the appearance of the device in low light conditions.
